(19) United States
(12) Patent Application Publication
(10) Pub. No.: US 2015/0142207 A1
(43) Pub. Date: May 21, 2015

(54) METHOD AND DRIVER ASSISTANCE DEVICE FOR SUPPORTING LANE CHANGES OR PASSING MANEUVERS OF A MOTOR VEHICLE

(71) Applicants: Folko Flehmig, Schoderstr (DE); Udo Schulz, Vaihingen/Enz (DE)

(72) Inventors: Folko Flehmig, Schoderstr (DE); Udo Schulz, Vaihingen/Enz (DE)

(73) Assignee: ROBERT BOSCH GMBH, Stuttgart (DE)

(21) Appl. No.: 14/542,021

(22) Filed: Nov. 14, 2014

(30) Foreign Application Priority Data
Nov. 18, 2013 (DE) 10 2013 223 428.7

(51) Int. Cl. B60W 30/00; G01C 21/34

(52) U.S. Cl. CPC B60W 30/00; G01C 21/3492
USPC 701/1

(57) ABSTRACT

In a method for operating a driver assistance device for supporting lane changes and/or passing maneuvers of a motor vehicle, route information of motor vehicles participating in a traffic situation is acquired; a target trajectory for a possible lane change or a possible passing maneuver, as well as at least one variable of the motor vehicle for reaching the target trajectory, are determined; a cost function is determined for the target trajectory and for the at least one variable; and the cost function is minimized in order to obtain a trajectory that is optimized with respect to costs.

### BACKGROUND OF THE INVENTION

1. Field of the Invention

The present invention relates to a method, a computer program and a driver assistance device for supporting lane changes and/or passing maneuvers of a motor vehicle according to the preambles of the respective independent claims.

2. Description of the Related Art

In the field of motor vehicle technology, lane change assistant systems and avoidance systems are known in which the driver of a motor vehicle is warned when vehicles are situated in an adjacent lane, or are approaching rapidly, so that a safe passing maneuver is not possible. These systems observe traffic behind the home vehicle using a rear-directed radar sensor system or a video system. When there is a vehicle in the adjacent lane, a warning message is communicated to the driver, or an intervention may even be carried out in the steering system and/or brake system (e.g., brake engagement at one side) of the vehicle in order to prevent the vehicle from veering into the adjacent lane.

In the named avoidance systems, when an approach of a second vehicle is recognized, a collision is prevented by active veering or evasion of the home vehicle.

In addition, so-called Adaptive Cruise Control (ACC) systems are known in which the longitudinal guiding of a motor vehicle is automated by specifying suitable drive and deceleration moments. In the case of a recognized vehicle traveling in front, the vehicle speed is adapted to the vehicle traveling in front; otherwise, regulation takes place to a target speed specified by the driver.

In addition, from Published European patent application document EP 2 169 649 A1 a method is known for providing a recommendation for carrying out a passing maneuver of a motor vehicle in which it is provided that, along a stretch of a lane, a first vehicle is approached from behind by a second vehicle following the first vehicle. In the evaluation of the passing situation for the second vehicle, route information of the first vehicle is used, providing information about further travel of the first vehicle. A passing maneuver is not recommended when the route information indicates that the first vehicle will promptly be leaving the stretch.

The method described in Published European patent application document EP 2 169 649 A1 also includes a driving situation in which the second vehicle has a higher speed than the first vehicle, so that, due to the different speeds of the two vehicles, passing is a possibility for the second vehicle. If, on the basis of the route information of the first vehicle, it is to be expected that the first vehicle travels in front of the second vehicle with a comparatively lower speed for the immediately following time period, the driver of the second vehicle receives the recommendation to carry out the passing maneuver. Correspondingly, the driver of the second vehicle is advised not to carry out the passing maneuver if the first vehicle, traveling in front, promptly departs from the lane.

In normal traffic, both on streets having one lane in a direction of travel with direct oncoming traffic and on highways or high-speed streets having two or more lanes without direct oncoming traffic, it additionally is often the case that a slower vehicle traveling in front could be passed by a following vehicle, but an opportunity for a safe change to a passing lane is missed. As a rule, this requires braking and, after the passing maneuver has taken place, re-acceleration of the passing vehicle, thus increasing fuel or energy consumption (the latter for example in the case of an electric vehicle).

### BRIEF SUMMARY OF THE INVENTION

The present invention is based on the idea of carrying out a change of lane or passing maneuver of a vehicle traveling in front by a following (home) vehicle in such a way that a braking of the passing vehicle is prevented to the greatest possible extent. Through a distance determination of the vehicles involved in the respective driving situation, i.e. the vehicle traveling immediately in front and the following vehicle, and through estimation or prediction of the movements of the vehicles involved, a passing maneuver that is optimal with respect to the distances and speeds of the involved vehicles is recommended to the driver, or it is recommended that the maneuver not be carried out, or the maneuver is automatically carried out or prevented.

The determination of an optimal passing maneuver takes place on the basis of a determined optimal trajectory that includes both a target trajectory and also corresponding variables of the motor vehicle in order to achieve the target trajectory. The determination of the trajectory takes place in the longitudinal direction, or travel direction, of the home vehicle, both for the home lane and also for at least one adjacent lane. On the basis of a determined optimal trajectory, the calculation of a cost function takes place, as does a subsequent or simultaneous minimization of the cost function. The time window for this optimization process is preferably large enough to make it possible to achieve a stable speed after the change of lane or passing maneuver has taken place.

In the determination of an optimal trajectory, in particular the fulfillment of secondary conditions is taken into account, these secondary conditions preferably relating to safety limits and/or comfort limits for the driving operation of the motor vehicle.

In a preferred embodiment, on the basis of a trajectory optimized as described in the longitudinal direction both for the home lane and for an adjacent lane, in addition an optimal trajectory is determined both in the longitudinal and in the transverse direction of the lane for an assumed change of lane, named secondary conditions relating to, if warranted, a plurality of vehicles being taken into account.

The route information of the vehicles participating in a current traffic situation required for the assessment of the traffic situation can be acquired or determined using known radar and/or video sensor systems. Alternatively or in addition, it can be provided to use existing data of a navigation system, e.g. the current position of the vehicle, the further course of the roadway including the number of lanes, entry and exit points, and intersections, the inclination of the roadway, curve radii, traffic signs, speed limits, or the like as named route information. In the case of vehicles that are networked in terms of data or communication, the driving behavior of a test collective can be determined or used, or the driving behavior of the current driver can be analyzed and, if warranted, trained.

Through the method according to the present invention, or the driver assistance device, unnecessary braking processes and acceleration processes can be effectively prevented, so that lane change or passing maneuvers can be carried out more efficiently with respect to energy or fuel. Through the determination of an optimal time for a lane change, the overall passing process can also be made safer from the point of view of driving.

The present invention can be used in all kinds of motor vehicles operated on roadways, including passenger vehicles, trucks or utility vehicles, motorcycles, or the like, with the advantages described herein.

Further advantages and embodiments of the present invention result from the description and from the accompanying drawings.

It will be understood that the features named above and explained below can be used not only in the respectively indicated combination, but also in other combinations, or by themselves, without departing from the scope of the present invention.

### BRIEF DESCRIPTION OF THE DRAWINGS

FIG. 1 shows, in a schematic top view, a driving or traffic situation typical for the present invention.

FIG. 2 shows a first exemplary embodiment of the method according to the present invention.

FIG. 3 shows a second exemplary embodiment of the method according to the present invention.

### DETAILED DESCRIPTION OF THE INVENTION

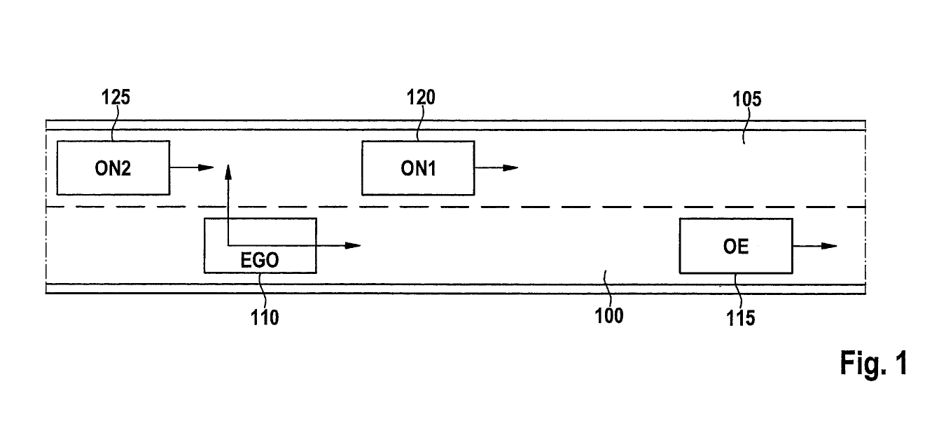

The driving situation shown in FIG. 1 relates to a two-lane roadway having a home lane 100 and an adjacent lane 105 (in the same direction of travel). A home vehicle (“Ego”) 110 is depicted on home lane 100, and a first foreign vehicle (“OE”) 115 is traveling in front of home vehicle 110. On adjacent lane 105, two further foreign vehicles (“ON1,” “ON2”) 120, 125 are depicted, foreign vehicle 120 traveling in front of home vehicle 110 and foreign vehicle 125 following home vehicle 110. In addition, the X, Y coordinate system used herein is depicted for home vehicle 110, the X axis being oriented in the roadway or travel direction and the Y axis being oriented transverse to the roadway or travel direction.

The method described in the following on the basis of two exemplary embodiments is based on a combined determination or planning of an optimal trajectory for a change of lane both in the longitudinal direction (X direction) and in the transverse direction (Y direction). First, a target trajectory x(t) is determined in the longitudinal direction, as are corresponding variables u(t) of the motor vehicle or of the engine by which the movement equation x(t) can be reached. Typical variables can be the engine torque (both for internal combustion engines and for electric motors), the selected gear, or the coupling status. However, quantities such as, for example, summed or wheel torques of a friction brake, starter/generator torques, steering angle, steering moments, steering wheel vibrations, and, in an electrically operated motor vehicle, drive and/or recuperation torques of an electric motor in the drive train, may also be variables. The equation system x(t), u(t) is here calculated such that a cost function J is minimized. Cost function J is calculated over a time span 0≦t≦t_{J}, where t_{J} is selected large enough that at the end of a lane change or passing maneuver of the home vehicle, a stable state is present with travel at a constant speed.

In the trajectory planning, limitations or secondary conditions caused by at least one further foreign vehicle participating in the traffic situation are taken into account, at which vehicle particular safety and/or comfort limits must be maintained. These limits are typically proportional to the speeds of the at least two vehicles taken into account and/or to the difference in speed between the at least two vehicles taken into account, in accordance with the following equations:

x_{Obj}(t)−x(t)<a*v(t) (1)

x_{Obj}(t)−x(t)<b*[v(t)−v_{Obj}(t)] (2)

where coefficients a and b, used here and in the following, are constants that are to be determined empirically.

On the basis of an optimal trajectory planning in the longitudinal direction, the optimal solution is calculated for the combined planning problem in the longitudinal and transverse direction for a change of lane, for which as a rule a plurality of foreign vehicles (i.e., vehicles also situated on the adjacent lane) are taken into account.

In the traffic situation shown in FIG. 1, for each object the distances in the longitudinal direction and the longitudinal speeds are known. These can be acquired using a named sensor system. For object (“OE)” 115, these are quantities x_{OE} and V_{xOE}. The lateral distances between the objects are also known, e.g. distance y_{OE} between home vehicle 110 and foreign vehicle 115.

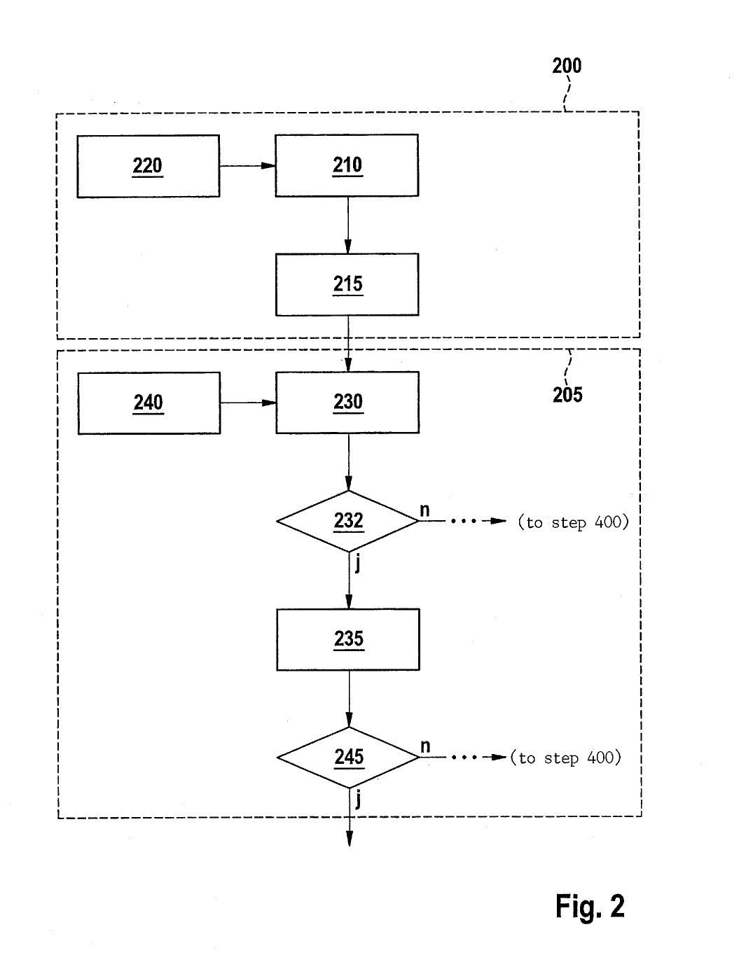

The first exemplary embodiment of the method according to the present invention, shown in FIG. 2, is made up of two subroutines 200, 205, including a first routine 200 for determining an optimal trajectory taking into account only the traffic or driving situation in home lane 100, and a following, second routine 205 for determining an optimal trajectory additionally taking into account the driving situation in adjacent lane 105.

According to first routine 200, first a trajectory x_{E}(t), u_{E}(t) that is as optimal as possible with regard to the longitudinal guiding in home lane 100 is determined, in step 210. This takes place taking into account data 220 that are acquired by sensors (radar sensors or the like) or by video. In the present exemplary embodiment, the named data 220 include in particular position x_{oE}, speed v_{xOE}, and position y_{oE} transverse to the travel of direction of foreign vehicle 115 traveling in front. The relevant time interval until a stationary state is reached is in this case t_{E}. In the following step 215, a named cost function J_{E} is calculated on the basis of calculated trajectory 210 and data 220 acquired by sensors or by video.

In first step 230 of second routine 205, again first a trajectory x_{N}(t), u_{N}(t) is determined that is as optimal as possible with regard to the longitudinal guiding, and in the present case with regard to adjacent lane 105. This takes place taking into account further data 240 acquired by sensors or by video, in particular relating to foreign vehicles participating in the traffic situation and situated in adjacent lane 105, i.e. in the present case foreign vehicles 120, 125. In the present exemplary embodiment, named data 240 include in particular positions x_{ON1}, x_{ON2}, speeds v_{xON1}, v_{xON2}, and positions y_{ON1}, y_{ON2} transverse to the direction of travel of foreign vehicles 120, 125. The relevant time interval until a stationary state is reached is in this case t_{N}.

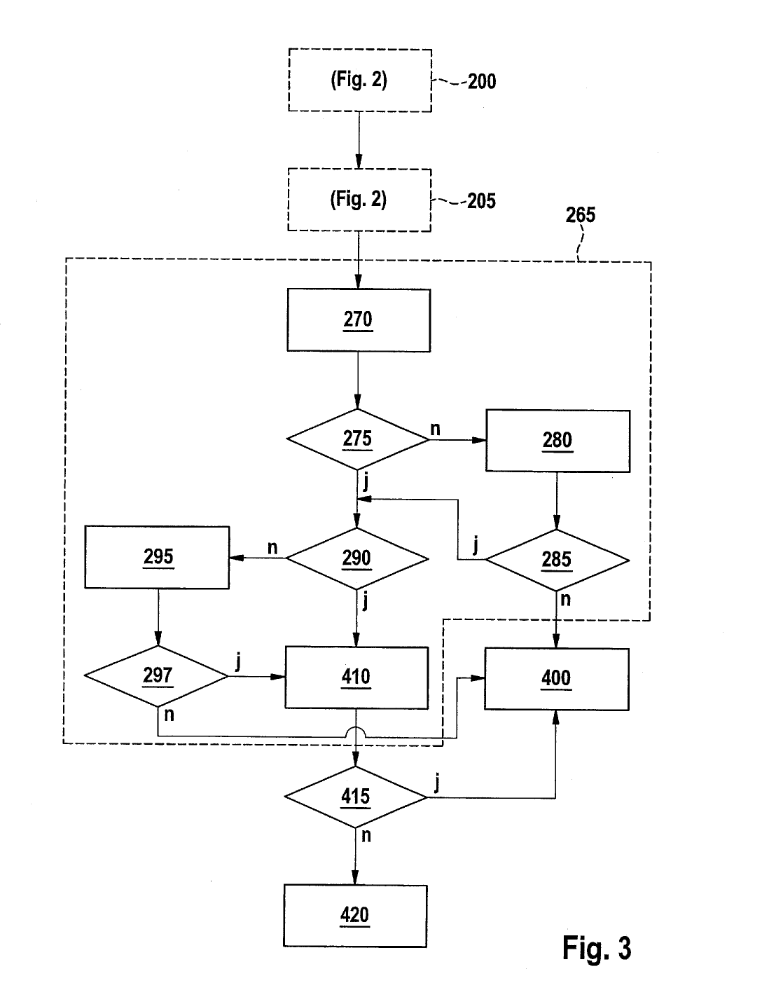

In step 232, it is checked whether for the trajectory determined in step 230 the named secondary conditions relating to driving safety and/or comfort have been met. If this is not the case, a jump takes place to step 400 (see FIG. 3). In the following step 235, on the basis of trajectory 230 and data 240 acquired by sensors or by video, a named cost function J_{N} is calculated. In step 245, it is in turn checked whether cost function J_{N} calculated in this way is smaller than J_{E}. If this is not the case, again a jump takes place to step 400. Otherwise, the routine is continued as shown in FIG. 3.

The overall routine shown in FIG. 3 is based on the two subroutines 200, 205 shown in FIG. 2, or follows these, in the present exemplary embodiment as further subroutine 265. Accordingly, subroutine 265 relates to the processing of the named secondary conditions. It is to be noted that the partitioning of the overall routine shown in FIGS. 2 and 3 into subroutines 200, 205, 265 is indicated only as an example, and the overall routine can also be articulated or composed differently.

In first step 270 of subroutine 265, there takes place the determination or estimation of the required time duration Δt_{SPW} for a change of lane of the home vehicle 110. The estimation can take place in various ways. Thus, a calculation can take place on the basis of the average transverse acceleration a_{y} when there is a change of lane and the lateral distance Δy_{SPW} for a change of lane on the basis of the following equation (3):

a_{y}≈Δt²_{SPW}*Δy_{SPW} (3)

where Δy_{SPW} can in turn be calculated from the lane width and relative position of foreign vehicle “OE” 115 relative to home vehicle “EGO” 110. Here, in addition a comfortable distance from vehicle “OE” 115 traveling in front can be taken into account. Alternatively, time duration Δt_{SPW} can be determined from the driving characteristic of a test collective (e.g. in the case of a networking of vehicles in terms of data or communication), or by training the driving characteristic of the current driver, for example by evaluating lane markings and/or steering movements.

Following step 270, in step 275 it is checked whether the named secondary conditions for the trajectory x_{N}(t), u_{N}(t) are met, because a change of lane must not infringe the safety and comfort limits with regard to vehicle “OE” 115 traveling in front as long as the change of lane has not been concluded. In this check, in the present exemplary embodiment the following three equations or conditions (4)-(6), are used as a basis:

x_{OE}(t)−x_{N}(t)<a*v_{N}(t) (4)

x_{OE}(t)−x_{N}(t)<b*[v_{N}(t)−v_{OE}(t)] (5)

0≦t≦Δt_{SPW} (6)

If these conditions are not met, then a delayed change of lane is planned (step 280). Otherwise, the execution of the routine is continued in step 290.

In step 280, a trajectory made up of two segments is planned. The first trajectory segment is made as optimal as possible in time span Δt_{SPW} and is planned in relation to foreign vehicle “OE” 115. Beginning from the end state of this trajectory segment, the second segment is determined as a trajectory that is as optimal as possible in relation to foreign vehicle “ON1”. The newly calculated trajectory replaces the previous trajectory x_{N}(t), u_{N}(t).

In step 285, it is checked whether in step 280 it was possible to determine a valid trajectory with regard to OE and ON. If this is the case, the execution continues with step 290. If not, a change of lane is not possible (step 400).

In step 290, in addition the fulfillment of the secondary conditions is checked with regard to traffic behind the home vehicle, i.e. in the present scenario according to FIG. 1 with regard to foreign vehicle “ON2” 125, following in adjacent lane 105. Here, a cooperative reaction of foreign vehicle 125 via its own deceleration can also be taken into account.

For foreign vehicle “ON2” 125, a trajectory xON2(t) is calculated for which the following three conditions (7)-(9) are met:

x_{N}(t)−x_{ON2}(t)<a*v_{ON2}(t) (7)

x_{N}(t)−x_{ON2}(t)<b*[v_{ON2}(t)−v_{N}(t)] (8)

0≦t≦Δt_{N1} (9)

If conditions (7)-(9) can be met, then in principle a change of lane is possible or permissible, and x_{N}(t) is selected as the optimal longitudinal trajectory (step 410).

In step 295, a trajectory made up of two segments is determined. In the first segment, for a time span t_{N}2 a trajectory is planned that is as optimal as possible with regard to vehicle ON2, so that at t_{N}2 the speed of the home vehicle is equal to the speed of vehicle ON2. The second segment is determined to be as optimal as possible relative to vehicle ON1 and has as initial value the end state of the first trajectory segment. The newly calculated trajectory replaces the previous trajectory x_{N}(t), u_{N}(t).

In step 297, it is checked whether the trajectory calculated in step 295 meets the secondary conditions. If the conditions are met, a jump takes place to step 410, and if not a jump takes place to step 400. In step 400, a change of lane is not recommended to the driver.

In step 410, in addition to the calculation of the named cost functions J_{E} and J_{N} there also takes place the calculation of a terminating cost function ΔJ(Δx, v)+ΔJP(v, v_{ref}). The terminating cost function enables a terminating correction of the respectively different stretches x_{E}(t_{E}), x_{N}(t_{N}), as well as required end speeds for remaining in home lane 100 and for a change of lane to adjacent lane 105. The first term ΔJ(Δx, v) of the terminating cost function relates to the continuation of the travel of home vehicle “Ego” 110 with its present (i.e. constant) speed. The different end speed is taken into account through addition of the second penalty term ΔJP(v, v_{ref}), which takes into account the deviation of the speed required for a recommended passing process from a reference or set speed v_{ref}, and which is for example proportional to the difference of the squares of the speeds (v²−v_{ref}²).

In the following step 415, there takes place a comparison of the possible trajectories on the basis of the overall lowest costs, taking into account the terminating cost function. If the previous trajectory x_{N}(t), u_{N}(t) is more advantageous for a lane change, then this trajectory is selected and a jump is made to step 420. Otherwise, there takes place a jump back to step 400, in which a change of lane is not recommended, or is discouraged. In step 420, a change of lane is recommended to the driver.

The described recommendations or indications to the driver (passing or change of lane possible or not possible) can be made using existing display means of the dashboard, optically and/or acoustically if warranted, or using a separate display means (e.g. LCD display or head-up display). Here, the positions of the vehicles participating in the traffic situation, and/or the calculated trajectories, including lane changes, can be displayed, and/or the time span can be indicated within which a passing of a vehicle traveling in front is safely possible without using the brakes. In the case of a displayed (e.g. graphically illustrated) selected or recommended trajectory, the alternative trajectories can also be displayed, together with the (additional) costs connected therewith.

The described recommendations to the driver can also include recommendations for braking or acceleration in the home lane, in order to achieve the relative speed, with regard to the foreign vehicle traveling in front, required for the passing maneuver.

In the case in which the home vehicle is a hybrid vehicle, the electrical and/or combustion-related drive power required for a passing maneuver recommended to the driver can be taken into account in look-ahead fashion in the memory management system.

The described method can be realized either in the form of a control program in an existing control device for controlling an internal combustion engine, or in the form of a corresponding control unit.

What is claimed is:

1. An automated method for supporting at least one of a change of lane and a passing maneuver of a host motor vehicle currently traveling in a home lane, comprising:
acquiring route information of at least one motor vehicle participating in a traffic situation surrounding the host motor vehicle;
determining a target trajectory for at least one of a possible lane change and a passing maneuver, as well as at least one variable of the host motor vehicle for reaching the target trajectory;
determining a cost function for the target trajectory and for the at least one variable; and
minimizing the cost function in order to obtain a final trajectory which is optimized with respect to costs.

2. The method as recited in claim 1, wherein:
the target trajectory is determined at least in the longitudinal direction relative to the home lane and at least one adjacent lane; and
for a change of lane, the target trajectory is additionally determined in the direction transverse to the home lane.

3. The method as recited in claim 2, wherein a time window for the determination of the target trajectory is selected to be sufficiently long such that after at least one of the lane change and the passing maneuver has taken place, a stable speed of the motor vehicle is able to be achieved.

4. The method as recited in claim 1, wherein a target trajectory for a lane change is determined by calculating at least one trajectory in the longitudinal direction of the vehicle.

5. The method as recited in claim 1, wherein the target trajectory includes at least (i) a first target trajectory segment relating to a motor vehicle traveling in front of the host motor vehicle in the home lane, and (ii) a second target trajectory segment which begins at the end of the first target trajectory segment and relating to a motor vehicle situated in an adjacent lane.

6. The method as recited in claim 5, wherein for the determination of the target trajectory, at least one secondary condition which relates to at least one of a safety limit and a comfort limit for the driving operation of the motor vehicle is taken into account that.

7. The method as recited in claim 6, wherein the at least one secondary condition relates to the at least one other motor vehicle participating in the driving situation, and wherein the at least one second condition is determined by at least one of (i) the speeds of the at least one other motor vehicle and the host vehicle, and (ii) the speed difference between the at one other motor vehicle and the host vehicle.

8. The method as recited in claim 7, wherein at least the following two equations are taken as the secondary conditions:
x_{Obj}(t)−x(t)<a*v(t) (1)
x_{Obj}(t)−x(t)<b*[v(t)−v_{Obj}(t)] (2)
where the index “Obj” indicates the at least one other motor vehicle participating in the traffic situation, and coefficients a and b represent constants which are determined empirically.

9. The method as recited in claim 5, wherein as the at least one variable of the motor vehicle includes: an engine torque; a selected gear; a coupling state; summed torque of at least one friction brake; a wheel torque of at least one friction brake; a starter torque; a generator torque; a steering angle; a steering torque; a steering wheel vibration; a drive torque of an electric motor in the drive train; and a recuperation torque of an electric motor in the drive train.

10. The method as recited in claim 5, wherein the route information is at least one of data acquired using a distance radar system, data acquired using a video system, data of a navigation system, data relating to the driving characteristic of a selected driver, and data relating to the driving characteristic of a current driver of the host motor vehicle.

11. A driver assistance device for an automated assistance of at least one of a change of lane and a passing maneuver of a host motor vehicle currently traveling in a home lane, comprising:
a control unit including a processor configured to:
acquire route information of at least one motor vehicle participating in a traffic situation surrounding the host motor vehicle;
determine a target trajectory for at least one of a possible lane change and a passing maneuver, as well as at least one variable of the host motor vehicle for reaching the target trajectory;
determine a cost function for the target trajectory and for the at least one variable; and
minimize the cost function in order to obtain a final trajectory which is optimized with respect to costs.

12. A non-transitory computer-readable data storage medium storing a computer program having program codes which, when executed on a computer, performs an automated method for supporting at least one of a change of lane and a passing maneuver of a host motor vehicle currently traveling in a home lane, the method comprising:
acquiring route information of at least one motor vehicle participating in a traffic situation surrounding the host motor vehicle;
determining a target trajectory for at least one of a possible lane change and a passing maneuver, as well as at least one variable of the host motor vehicle for reaching the target trajectory;
determining a cost function for the target trajectory and for the at least one variable; and
minimizing the cost function in order to obtain a final trajectory which is optimized with respect to costs.
